(19) United States
(12) Patent Application Publication
(10) Pub. No.: US 2014/0005806 A1
(43) Pub. Date: Jan. 2, 2014

(54) INFORMATION PROCESSING DEVICE, INFORMATION DISPLAY APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Daisuke YAMAMOTO, Kanagawa (JP); Yuto YAMAJI, Tokyo (JP); Yuka KOBAYASHI, Tokyo (JP); Tsuyoshi TASAKI, Kanagawa (JP); Hiroshi SUGIYAMA, Kanagawa (JP)

(73) Assignee: KABUSHIKI KAISHA TOSHIBA, Tokyo (JP)

(21) Appl. No.: 13/858,346

(22) Filed: Apr. 8, 2013

(30) Foreign Application Priority Data
Jun. 29, 2012 (JP) 2012-146624

(51) Int. Cl. G05B 15/02

(52) U.S. Cl. CPC G05B 15/02
USPC 700/83

(57) ABSTRACT

According to an embodiment, an processing device includes a first obtaining unit, a second obtaining unit, and a display controller. The first obtaining unit is configured to obtain location information which indicates a location of a user. The second obtaining unit is configured to obtain movement information which indicates a movement performed by the user. The display controller is configured to perform control to display a personification medium on a display unit on which service information indicating information to be offered to the user. The personification medium fixes vision in a direction corresponding to the location specified in the location information and performs a movement in synchronization with the movement specified in the movement information.

### CROSS-REFERENCE TO RELATED APPLICATIONS

This application is based upon and claims the benefit of priority from Japanese Patent Application No. 2012-146624, filed on Jun. 29, 2012; the entire contents of which are incorporated herein by reference.

### FIELD

Embodiments described herein relate generally to an information processing device, an information display apparatus, an information processing method, and a computer program product.

### BACKGROUND

Typically, a technology is known by which information intended for a particular user is presented with the use of a personification medium. For example, a technology is known by which a personification medium that is expressed using computer graphics (hereinafter, referred to as “CG”) fixes vision on the location of a user with the aim of approaching the user.

However, in such technologies, if a plurality of users is present, then it is difficult to make a particular user recognize that the user is the target for offering services.

### BRIEF DESCRIPTION OF THE DRAWINGS

FIG. 1 is a block diagram illustrating an information display apparatus according to a first embodiment;

FIG. 2 is a schematic diagram for explaining a method of setting the line-of-sight direction of a personification medium according to the first embodiment;

FIG. 3 is a schematic diagram for explaining a movement of the personification medium according to the first embodiment;

FIG. 4 is a schematic diagram illustrating personification mediums according to a second modification example of the first embodiment;

FIG. 5 is a block diagram illustrating an information display apparatus according to a second embodiment;

FIG. 6 is a schematic diagram illustrating an exemplary arrangement of personification mediums according to the second embodiment; and

FIG. 7 is a schematic diagram illustrating an exemplary arrangement of personification mediums according to a first modification example of the second embodiment.

### DETAILED DESCRIPTION

According to an embodiment, an processing device includes a first obtaining unit, a second obtaining unit, and a display controller. The first obtaining unit is configured to obtain location information which indicates a location of a user. The second obtaining unit is configured to obtain movement information which indicates a movement performed by the user. The display controller is configured to perform control to display a personification medium on a display unit on which service information indicating information to be offered to the user. The personification medium fixes vision in a direction corresponding to the location specified in the location information and performs a movement in synchronization with the movement specified in the movement information.

Various embodiments will be described in detail below with reference to the accompanying drawings.

### First Embodiment

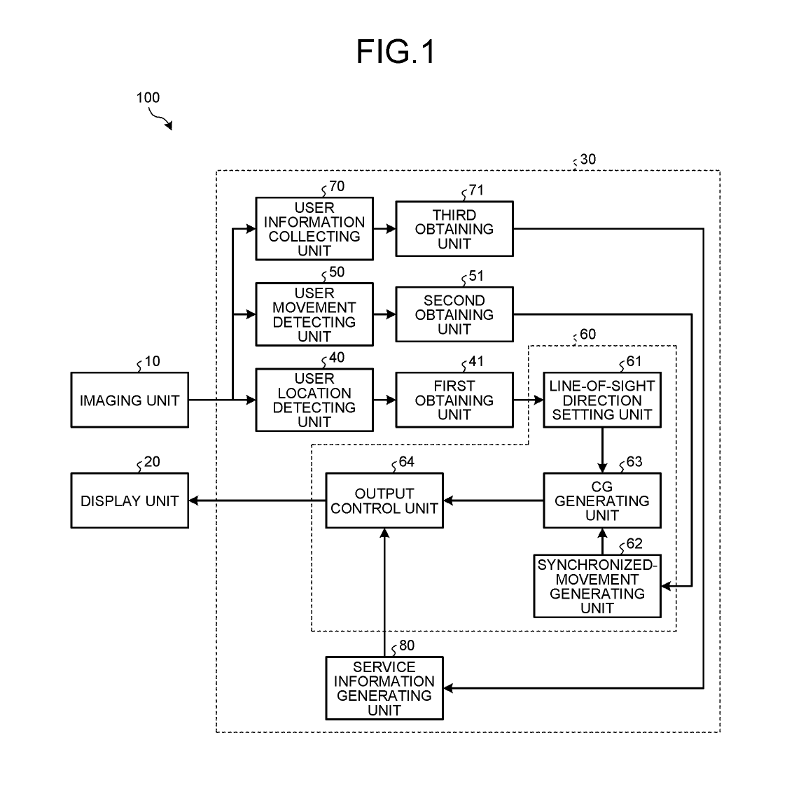

FIG. 1 is a block diagram illustrating a configuration example of an information display apparatus 100 according to a first embodiment. In this example, with respect to the people present in the vicinity of the information display apparatus 100, the information display apparatus 100 offers service information such as advertisements using a digital signage. As illustrated in FIG. 1, the information display apparatus 100 includes an imaging unit 10, a display unit 20, and an information processing unit 30. The imaging unit 10 captures images of an area in the vicinity of the information display apparatus 100. In the first embodiment, a camera is used as the imaging unit 10. However, that is not the only possible case. The image data obtained by the imaging unit 10 by means of capturing images is input to the information processing unit 30. Herein, the image data obtained by the imaging unit 10 by means of capturing images can be still images or moving images.

The display unit 20 is a device for displaying images and is configured with a display device such as a liquid crystal display device.

As illustrated in FIG. 1, the information processing unit 30 includes a user location detecting unit 40, a first obtaining unit 41, a user movement detecting unit 50, a second obtaining unit 51, a display control unit 60, a user information collecting unit 70, a third obtaining unit 71, and a service information generating unit 80.

The user location detecting unit 40 detects the location of users who appear in the image data that is obtained by the imaging unit 10 by means of capturing images (i.e., users who are present in the vicinity of the information display apparatus 100). More particularly, the user location detecting unit 40 refers to the image data that is obtained by the imaging unit 10 by means of capturing images, and detects locations of the head regions of users captured in the image data using a known technique such as the human face detection technique or the human detection technique. Alternatively, it is possible to use a plurality of cameras as the imaging unit 10, and to make use of the image data obtained by each camera by means of capturing images for detecting the location of users who are present in the area near the information display apparatus 100. Meanwhile, in the first embodiment, the explanation is given under the assumption that only a single user is present in the area near the information display apparatus 100.

Thus, in the first embodiment, a camera is used as the imaging unit 10; and the user location detecting unit 40 refers to the image data obtained by the camera by means of capturing images and detects the location of the user who is present in the vicinity of the information display apparatus 100. However, that is not the only possible case, and any arbitrary method can be implemented to detect the location of the user. For example, a sensor such as a laser range finder can be used as the imaging unit 10; and the user location detecting unit 40 can refer to the sensing result of the sensor and accordingly detect the location of the user who is present in the vicinity of the information display apparatus 100.

The first obtaining unit 41 obtains location information that indicates the user location. In the first embodiment, the first obtaining unit 41 obtains location information that indicates the location of the head region of the user as detected by the user location detecting unit 40.

The user movement detecting unit 50 detects movements of the user who appears in the image data that is obtained by the imaging unit 10 by means of capturing images. More particularly, the user movement detecting unit 50 refers to the image data that is obtained by the imaging unit 10 by means of capturing images; implements a known gesture recognition technique to detect movements of the user who is captured in that image data; and detects the movement amount, the movement direction, and the movement periodicity. Herein, the information detected by the user movement detecting unit 50 (i.e., the information indicating the user movement) is called movement information. Meanwhile, any type of movement can be considered as the target movement for detection. Herein, examples of the target movement for detection include a hand movement or a head movement (such as a nod or a shake).

The second obtaining unit 51 obtains movement information that indicates a movement performed by the user. In the first embodiment, the second obtaining unit 51 obtains the movement information that is detected by the user movement detecting unit 50.

The display control unit 60 performs control to display a personification medium, which fixes vision in the direction corresponding to the location specified in the location information obtained by the first obtaining unit 41 and which performs a movement in synchronization with the movement specified in the movement information obtained by the second obtaining unit 51, on the display unit 20. A more specific explanation is given below. In the following explanation, the personification medium is expressed using three-dimensional model CG. However, that is not the only possible case. Alternatively, for example, the personification medium can also be expressed using two-dimensional model CG. The personification medium is capable of fixing vision (i.e., has at least one eye), and includes movable parts (such as hands, legs, a head region, etc.) for performing movements in concert with the movements performed by the user (thus, the personification medium can be, for example, an animal, a fictional living object, or a robot).

As illustrated in FIG. 1, the display control unit 60 includes a line-of-sight direction setting unit 61, a synchronized-movement generating unit 62, a CG generating unit 63, and an output control unit 64. The line-of-sight direction setting unit 61 sets the line-of-sight direction of the personification medium according to the location specified in the location information that is obtained by the first obtaining unit 41. A more specific explanation is given below.

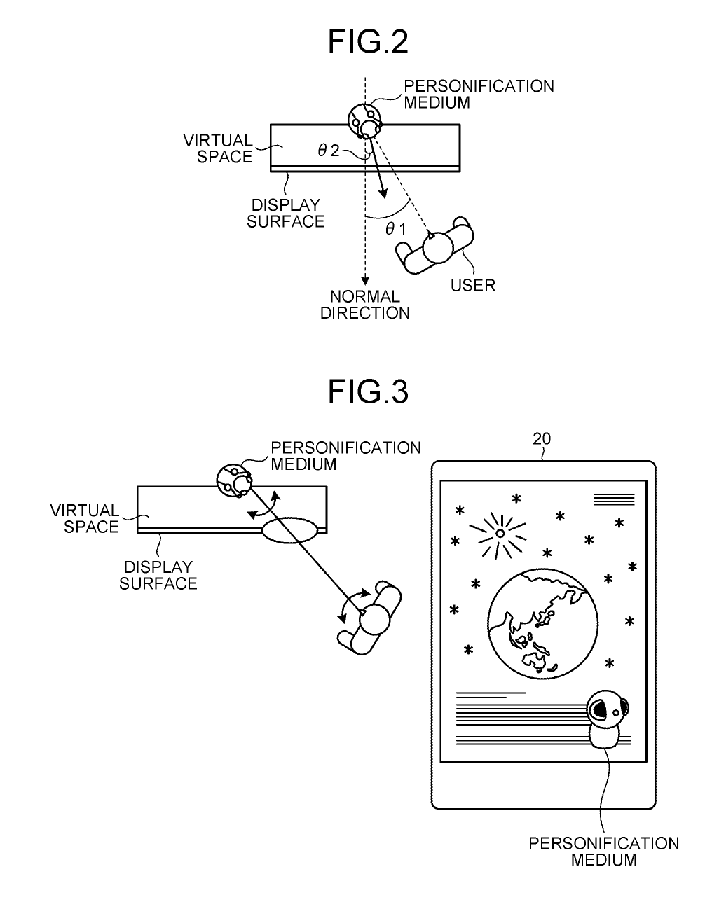

Herein, if the line-of-sight direction of the personification medium, which is displayed on the display unit 20, is within ±30° of the normal direction of a display surface, which is a surface of the display unit 20 on which images are displayed; an eye contact is established between the personification medium and the user who is observing the display surface. In the first embodiment, the line-of-sight direction setting unit 61 sets the line-of-sight direction of the personification medium in such a way that the angle formed between the normal direction of the display surface and the line-of-sight direction of the personification medium is equal to or smaller than one-third of the angle formed between the direction from a predetermined position of the personification medium toward the location specified in the location information obtained by the first obtaining unit 41 and the normal direction of the display surface. In the first embodiment, as illustrated in FIG. 2, it is assumed that the personification medium is positioned rearward by about 0.5 meters from the display surface. In the following explanation, the rearward portion of the display surface in which the personification medium is assumed to be present is called a virtual space. In the example illustrated in FIG. 2, the angle formed between the direction from a predetermined position of the personification medium toward the location of the user (i.e., the location specified in the location information that is obtained by the first obtaining unit 41) and the normal direction of the display surface is referred to as angle θ1. Thus, the line-of-sight direction setting unit 61 sets the line-of-sight direction of the personification medium in such a way that an angle θ2, which is formed between the line-of-sight direction of the personification medium and the normal direction of the display surface, is equal to or smaller than one-third of the angle θ1. With that, the line-of-sight direction of the personification medium can be set to be always within ±30° of the normal direction of the display surface.

Returning to the explanation with reference to FIG. 1, the synchronized-movement generating unit 62 generates synchronized-movement information, which indicates the movement of the personification medium, from the movement information obtained by the second obtaining unit 51. The synchronized-movement generating unit 62 generates the synchronized-movement information in such a way that the movement of the personification medium is synchronized with the movement specified in the movement information that is obtained from the second obtaining unit 51. For example, if the user performs a movement of vigorously waving the hands, then the synchronized-movement generating unit 62 generates the synchronized-movement information which indicates that the personification medium waves hands (or movable parts corresponding to “hands”) with the same periodicity as the periodicity at which the user waves the hands. Moreover, the synchronized-movement generating unit 62 generates the synchronized-movement information in such a way that, when the display surface is considered to be a plane of mirror symmetry, the personification medium performs a movement as a mirror image of the user. For example, as illustrated in FIG. 3, the synchronized-movement generating unit 62 generates the synchronized-movement information which indicates that, when the user performs a movement of turning the head region from side to side, the personification medium turns the head region (or the movable part corresponding to “head region”) with the same periodicity as the periodicity at which the user turns the head region but in the opposite direction to the direction in which the user turns the head region.

Furthermore, if the second obtaining unit 51 obtains the movement information which indicates the orientation of the face of the user detected by the user movement detecting unit 50, then the synchronized-movement generating unit 62 can generate the synchronized-movement information which indicates that the face (or the movable part corresponding to “face”) of the personification medium has the same orientation as the orientation of the face of the user.

The CG generating unit 63 refers to the line-of-sight direction set by the line-of-sight direction setting unit 61 and the synchronized-movement information generated by the synchronized-movement generating unit 62, and generates a CG of the personification medium that fixes vision in the line-of-sight direction set by the line-of-sight direction setting unit 61 and performs a movement specified in the synchronized-movement information generated by the synchronized-movement generating unit 62. The output control unit 64 performs control to display the personification medium, which is generated by the CG generating unit 63, on the display unit 20.

The user information collecting unit 70 collects, from the image data obtained by the imaging unit 10 by means of capturing images, the information related to the user who appears in the image data. More particularly, the user information collecting unit 70 can implement a known technique such as the human face detection technique with respect to the image data obtained by the imaging unit 10 by means of capturing images; can identify the age or the gender of the user, who appears in the image data, from the face image that is detected; and can collect the identification result as user information. Moreover, for example, face images and personal information of people corresponding to those face images can be registered in advance in a memory (not illustrated), and the user information collecting unit 70 can perform face recognition to match the detected face image with the already-registered face images so as to identify the user who appears in the image data. Then, the user information collecting unit 70 can collect the personal information corresponding to the identified user as the user information. Furthermore, in combination with a technique for continual registration of face images detected by means of face detection; the user information collecting unit 70 can collect, as the user information of a particular user, the information that indicates the frequency and the time at which that user having the face image thereof registered is present in the vicinity of the information display apparatus 100.

The third obtaining unit 71 obtains the user information that is collected by the user information collecting unit 70. The service information generating unit 80 generates service information, which indicates the information to be offered to the user, depending on the user information obtained by the third obtaining unit 71. For example, if the user information indicates that the user is a man in his sixties, then the service information generating unit 80 generates service information in the form of an advertisement image intended for men in their sixties. Moreover, if the user information also indicates that the user visits the area in the vicinity of the information display apparatus 100 every evening, then a speech balloon image displaying a message such as “Hope you had a good day.” can be generated along with the advertisement image. Besides, it is also possible to use a speaker (not illustrated) or a voice synthesizing unit (not illustrated) to deliver the contents of that message in the form of an audio message.

Meanwhile, alternatively, for example, the user information collecting unit 70 and the third obtaining unit 71 may not be disposed; and the service information generating unit 80 can generate service information, such as information of a product to be advertised or information of road navigation, without taking into account the user information.

The display control unit 60 (the output control unit 64) performs control to display the service information, which is generated by the service information generating unit 80, on the display unit 20.

In the first embodiment, the information processing unit 30 is a computer device having a hardware configuration that includes a central processing unit (CPU), a read only memory (ROM), and a random access memory (RAM). The CPU loads a computer program, which is stored in the ROM, in the RAM and executes it so that the functions of the user location detection unit 40, the first obtaining unit 41, the user movement detecting unit 50, the display control unit 60 (the line-of-sight direction setting unit 61, the synchronized-movement generating unit 62, the CG generating unit 63, and the output control unit 64), the user information collecting unit 70, the third obtaining unit 71, and the service information generating unit 80 are implemented. However, that is not the only possible case. Alternatively, for example, at least some functions from among the functions of the user location detection unit 40, the first obtaining unit 41, the user movement detecting unit 50, the display control unit 60, the user information collecting unit 70, the third obtaining unit 71, and the service information generating unit 80 can be implemented using special hardware circuits. Meanwhile, the information processing unit 30 corresponds to an “information processing device” mentioned in claims.

As described above, in the first embodiment, the display control unit 60 performs control to display a personification medium, which fixes vision in the direction corresponding to the location of a user (i.e., the location specified in the location information that is obtained by the first obtaining unit 41) and which performs a movement in synchronization with the movement of the user (i.e., the movement specified in the movement information that is obtained by the second obtaining unit 51), on the display unit 20 along with the service information intended for the user (i.e., the service information generated corresponding to the user information that is obtained by the third obtaining unit 71). If the user looks at the personification medium that performs a movement in synchronization with the movement performed by the user, then the user can feel as if the personification medium is approaching the user (i.e., the user can recognize that he or she is the target for offering services). Thus, the user can receive the service information which is tailored to the user.

### First Modification Example of First Embodiment

In the first embodiment, it is assumed that only a single user is present in the vicinity of the information display apparatus 100. However, for example, if two or more users are present in the vicinity of the information display apparatus 100, then the user who is closest to the display surface can be identified as the target for offering service information. Alternatively, for example, from among a plurality of users, the user who stays for the longest period of time in the area near the information display apparatus 100 can be identified as the target for offering service information. Still alternatively, for example, from among a plurality of users, a randomly-selected user can be identified as the target for offering service information. Then, the user location detecting unit 40 detects the location information corresponding to the user that has been identified; the user movement detecting unit 50 detects the movement information corresponding to the user that has been identified; and the user information collecting unit 70 collects the user information corresponding to the user that has been identified.

### Second Modification Example of First Embodiment

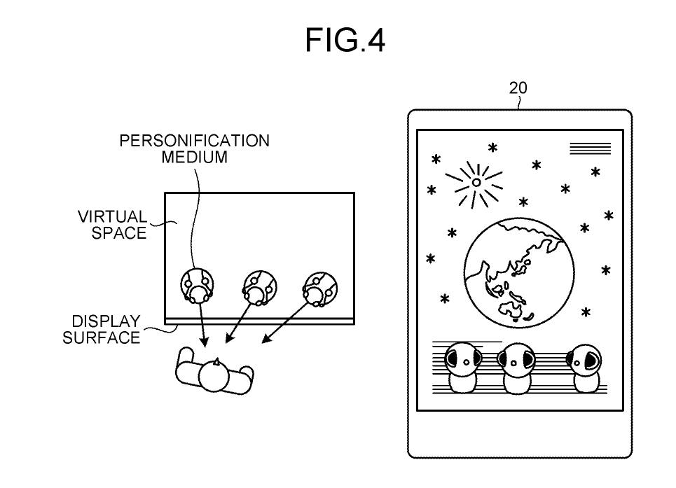

In the first embodiment, only a single personification medium is displayed on the display unit 20. However, that is not the only possible case. For example, as illustrated in FIG. 4, a plurality of personification mediums can be displayed on the display unit 20. In that case, the configuration can be such that all personification mediums fix vision at the direction corresponding to the location of the user and perform a movement in synchronization with the movement performed by the user; or the configuration can be such that only one of the personification mediums fixes vision at the direction corresponding to the location of the user and performs a movement in synchronization with the movement performed by the user. In essence, the configuration can be such that a plurality of personification mediums corresponding to a single user is displayed on the display unit 20, and at least one of the personification mediums fixes vision at the direction corresponding to the location of the user and performs a movement in synchronization with the movement performed by the user.

### Second Embodiment

Given below is the explanation of a second embodiment. As compared to the first embodiment, the second embodiment differs in the fact that two or more users are present in the vicinity of an information display apparatus; and control is performed in such a way that a plurality of personification mediums in a one-to-one correspondence with the users, is displayed on the display unit 20. A more specific explanation is given below. Meanwhile, regarding the constituent elements that are identical to those in the first embodiment, the explanation is not repeated.

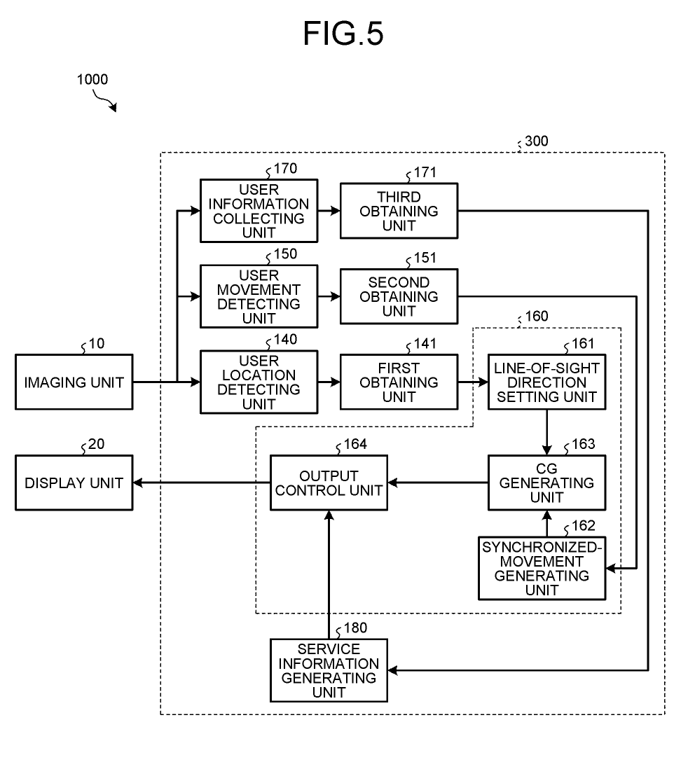

FIG. 5 is a block diagram illustrating a configuration example of an information display apparatus 1000 according to the second embodiment. In this example, with respect to the people present in the vicinity of the information display apparatus 1000, the information display apparatus 1000 offers service information such as advertisements using a digital signage. As illustrated in FIG. 5, the information display apparatus 1000 includes the imaging unit 10, the display unit 20, and an information processing unit 300.

As illustrated in FIG. 5, the information processing unit 300 includes a user location detecting unit 140, a first obtaining unit 141, a user movement detecting unit 150, a second obtaining unit 151, a display control unit 160, a user information collecting unit 170, a third obtaining unit 171, and a service information generating unit 180.

The user location detecting unit 140 detects the locations of a plurality of users who appear in the image data that is obtained by the imaging unit 10 (i.e., a plurality of users present in the area near the information display apparatus 1000). More particularly, the user location detecting unit 140 refers to the image data obtained by the imaging unit 10 by means of capturing images, and detects locations of the head regions of a plurality of users captured in that image data using a known technique such as the human face detection technique or the human detection technique. Then, with respect to each user, the user location detecting unit 140 sends an information group, which contains identification information (such as an ID) for identifying the user in a corresponding manner to the location information indicating the location of the head region of the user, to the first obtaining unit 141 and the user movement detecting unit 150. With that, the first obtaining unit 141 obtains the identification information and the location information for each user who is present in the vicinity of the information display apparatus 1000, and sends that information to the display control unit 160.

The user movement detecting unit 150 detects the movement performed by at least a single user from among a plurality of users who appears in the image data obtained by the imaging unit 10 by means of capturing images. In the second embodiment, the user movement detecting unit 150 is assumed to detect the movement performed by all users who appear in the image data obtained by the imaging unit 10 by means of capturing images. Based on the image data obtained by the imaging unit 10 by means of capturing images and the information groups received from the user location detecting unit 140, the user movement detecting unit 50 detects the movements performed by the users each of which is present at one of the locations of head regions detected by the user location detecting unit 140; and detects the movement amount, the movement direction, and the movement periodicity of each movement. Then, with respect to each user, the user movement detecting unit 150 sends an information group, which contains the identification information of that user in a corresponding manner to the movement information of that user, to the second obtaining unit 151. With that, the second obtaining unit 151 obtains the identification information and the movement information of each user who is present in the vicinity of the information display apparatus 1000, and sends that information to the display control unit 160.

In the second embodiment, the user movement detecting unit 150 detects the movements of all users who appear in the image data obtained by the imaging unit 10 by means of capturing images. However, that is not the only possible case. Alternatively, for example, the movements of only some of the users can be detected. For example, of a plurality of users, the movements of only those users who are closest to the display unit 20 (display) can be detected. In essence, the purpose is served as long as the user movement detecting unit 150 detects the movement of at least a single user from among a plurality of users who appears in the image data obtained by the imaging unit 10 by means of capturing images and as long as the second obtaining unit 151 obtains the movement information corresponding to at least a single user from among a plurality of users.

The display control unit 160 performs control to display, on the display unit 20, a plurality of personification mediums in a one-to-one correspondence with a plurality of users. More particularly, the display control unit 160 performs control to display personification mediums, which fix vision in the directions corresponding to the locations of users for which the movement information is obtained and which perform movements in synchronization with the movements performed by the users, on the display unit 20. In the second embodiment, since the movement information is obtained regarding all of a plurality of users; the display control unit 160 performs control to display personification mediums, each of which fixes vision in the direction corresponding to the location indicated by the location information of one of the users and performs a movement in synchronization with the movement indicated by the movement information of that user, on the display unit 20. A more specific explanation is given below.

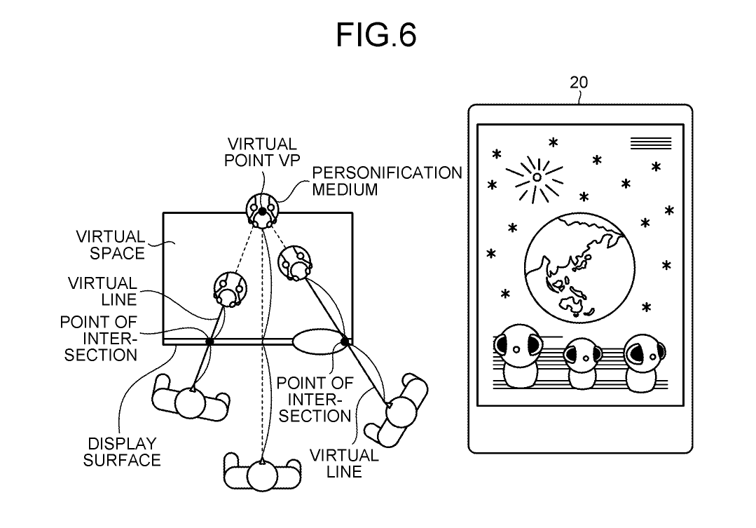

In the second embodiment, as illustrated in FIG. 6, a predetermined virtual point VP in the virtual space is set as the default position of each personification medium. Depending on the location of each user as specified in the location information; a line-of-sight direction setting unit 161 sets the line-of-sight direction of the personification medium corresponding to that particular user. In this example, in an identical manner to the first embodiment, the line-of-sight direction setting unit 161 sets the line-of-sight direction of a personification medium in such a way that the angle formed between the normal direction of the display surface and the line-of-sight direction of the personification medium is equal to or smaller than one-third of the angle formed between the direction from a predetermined position (the virtual point VP) of the personification medium toward the location specified in the location information obtained by the first obtaining unit 141 and the normal direction of the display surface.

A synchronized-movement generating unit 162 refers to the movement information of each user and generates synchronized-movement information indicating the movement of the personification medium corresponding to the user. In this example, in an identical manner to the first embodiment, the synchronized-movement generating unit 162 generates synchronized-movement information in such a way that the movements of the personification mediums are synchronized with the movements specified in the movement information that is obtained by the second obtaining unit 151.

A CG generating unit 163 refers to the line-of-sight direction set by the line-of-sight direction setting unit 161 and the synchronized-movement information generated by the synchronized-movement generating unit 162; and generates, for each user, a CG of a personification medium that fixes vision in the line-of-sight direction set by the line-of-sight direction setting unit 161 and performs a movement specified in the synchronized-movement information generated by the synchronized-movement generating unit 162. Then, an output control unit 164 performs control to display the personification mediums, which are generated by the CG generating unit 163, on the display unit 20.

The following explanation is given regarding the positioning of the personification medium corresponding to each user. In the second embodiment, as illustrated in FIG. 6, the CG generating unit 163 arranges each personification medium, which corresponds to a user present at a location specified in the location information that is obtained by the first obtaining unit 141, at a position that lies on a virtual line drawn from the virtual point VP in the virtual space to the user location specified in the location information and that is within the virtual space at a distance which is measured from the point of intersection between the corresponding virtual line and the display surface and which is equal to the distance between the user location specified in the location information and the corresponding point of intersection. Thus, the display control unit 160 according to the second embodiment preforms control to display the personification medium corresponding to each user in such a way that the personification medium corresponding to a user present at a particular location specified in the location information is set to a position that lies on the virtual line drawn from the virtual point VP to the user location specified in the location information obtained by the first obtaining unit 141 and that is within the virtual space at a distance which is measured from the point of intersection between the corresponding virtual line and the display surface and which is equal to the distance between the user location specified in the location information and the corresponding point of intersection.

Returning to the explanation with reference to FIG. 5, the user information collecting unit 170 refers to the image data obtained by the imaging unit 10 by means of capturing images and collects user information for each user who appears in the image data. The third obtaining unit 171 obtains the user information of each user collected by the user information collecting unit 170. Then, the service information generating unit 180 generates service information according to the user information of each user obtained by the third obtaining unit 171. Subsequently, the output control unit 164 performs control to display the service information, which is generated by the service information generating unit 180, on the display unit 20.

For example, if the user information indicates that the users include a large number of men in their sixties, then the service information generating unit 180 can generate service information in the form of an advertisement image intended for men in their sixties. Alternatively, for example, the service information generating unit 180 can make use of the user information of only those users who are closest to the display unit 20 from among a plurality of users and then generate the service information according to that user information. Still alternatively, for example, the service information generating unit 180 refers to the user information of each user and generates a speech balloon image displaying a message (for example, “Good morning. You are earlier than usual today.”) that is intended for the users. In that case, the output control unit 164 can perform control to display the personification medium corresponding to each user along with a speech balloon image that displays a message intended for the user.

In the second embodiment, the information processing unit 300 is a computer device having a hardware configuration that includes a CPU, a ROM, and a RAM. The CPU loads a computer program, which is stored in the ROM, in the RAM and executes it so that the functions of the user location detection unit 140, the first obtaining unit 141, the user movement detecting unit 150, the display control unit 160, the user information collecting unit 170, the third obtaining unit 171, and the service information generating unit 180 are implemented. However, that is not the only possible case. Alternatively, for example, at least some functions from among the functions of the user location detection unit 140, the first obtaining unit 141, the user movement detecting unit 150, the display control unit 160, the user information collecting unit 170, the third obtaining unit 171, and the service information generating unit 180 can be implemented using special hardware circuits. Meanwhile, the information processing unit 300 corresponds to the “information processing device” mentioned in claims.

As described above, when a plurality of users is present in the vicinity of the information display apparatus 1000; the display control unit 160 performs control to display, with respect to each user, a personification medium, which fixes vision in the direction corresponding to the location of the user and performs a movement in synchronization with the movement performed by the user, on the display unit 20 along with service information. If a user looks at the personification medium that corresponds to the location of that user and that performs a movement in synchronization with the movement of that user; then the user can feel as if the personification medium is approaching the user. Thus, the user can receive the service information which is tailored to that user.

### First Modification Example of Second Embodiment

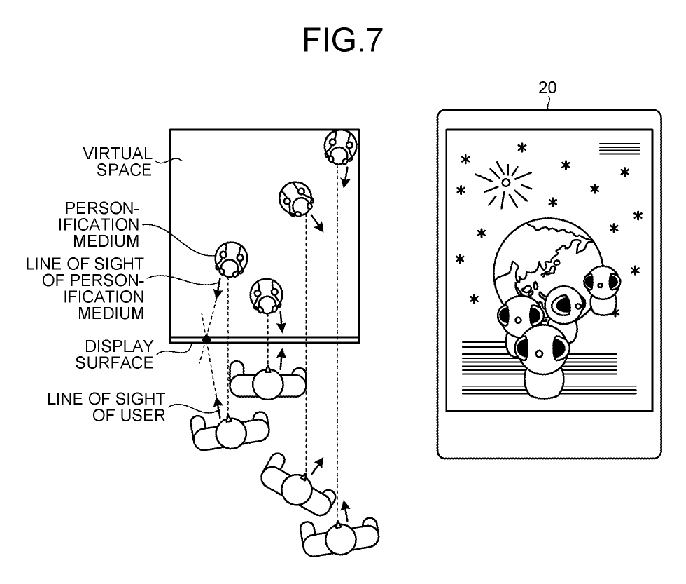

The positioning of the personification medium corresponding to each user is not limited to the example illustrated in FIG. 6. Alternatively, for example, as illustrated in FIG. 7, the CG generating unit 163 can arrange each personification medium, which corresponds to a user present at a location specified in the location information that is obtained by the first obtaining unit 141, at positions that, when the display surface is considered to be a plane of mirror symmetry, have a symmetric relation with the user location specified in the location information. Thus, the display control unit 160 can perform control to display the personification medium corresponding to each user in such a way that the personification medium corresponding to a user present at a location specified in the location information is arranged at a position that, in the virtual space, has a symmetrical relation with the user location specified in the location information when the display surface is considered to be a plane of mirror symmetry.

In this case, as illustrated in FIG. 7, the line-of-sight direction setting unit 161 sets the line-of-sight direction of the personification medium corresponding to each user in such a way that the line of sight of a user and the line of sight of the corresponding personification medium cross at the display surface. With that, each personification medium can be showcased as a mirror image of the corresponding user.

### Second Modification Example of Second Embodiment

As far as the CG of the personification medium is concerned, the same CG can be used among a plurality of users. Alternatively, for example, the configuration can be such that the personification medium corresponding to each user changes according to the user information of that user. For example, if a user is a child, then a character intended for children can be generated as the personification medium corresponding to the user; and if a user is an elderly person, then a character holding a stick can be generated as the personification medium corresponding to the user.

In each embodiment described above, the information processing unit 30 (300) has the function for detecting the location of a user who appears in the image data that is obtained by the imaging unit 10 by means of capturing images (i.e., the information processing unit 30 (300) includes the user location detecting unit 40 (140)). However, regarding that function, the configuration can be such that, for example, an external device (a server) is installed and the information processing unit 30 (300) obtains the detection result (the location information) from the external device. The same is the case regarding the user movement detecting unit 50 (150) and the user information collecting unit 70 (170). In essence, the purpose is served as long as the information processing device according to an aspect of the present invention includes a first obtaining unit that obtains location information indicating the location of a user; a second obtaining unit that obtains movement information indicating the movement performed by that user; and a display control unit that performs control to display a personification medium, which fixes vision in the direction corresponding to the location specified in the location information and performs a movement in synchronization with the movement specified in the movement information, on a display unit on which service information is also displayed.

In each embodiment described above, the configuration is such that the imaging unit 10, the display unit 20, and the information processing unit 30 (300) are installed in the same apparatus. However, that is not the only possible case. Alternatively, for example, the configuration can be such that the imaging unit 10, the display unit 20, and the information processing unit 30 (300) are installed independent of each other in a mutually-communicable manner. Still alternatively, for example, the configuration can be such that the imaging unit 10 and the display unit 20 are installed in a single apparatus, but the information processing unit 30 (300) is installed independently in a mutually-communicable manner with the apparatus. Still alternatively, for example, the configuration can be such that the information processing unit 30 (300) and the display unit 20 are installed in a single apparatus, but the imaging unit 10 is installed independently in a mutually-communicable manner with the apparatus. Still alternatively, for example, the configuration can be such that the imaging unit 10 and the information processing unit 30 (300) are installed in a single apparatus, but the display unit 20 is installed independently in a mutually-communicable manner with the apparatus.

Meanwhile, the computer program executed in the information processing unit 30 (300) can be saved in a downloadable manner on a computer connected to a network such as the Internet. Alternatively, the computer program executed in the information processing unit 30 (300) can be can be distributed over a network such as the Internet. Still alternatively, the computer program executed in the information processing unit 30 (300) can be in advance in a nonvolatile recording medium such as a ROM or the like.

Meanwhile, the embodiments and the modification examples thereof can be combined in an arbitrary manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a first obtaining unit configured to obtain location information which indicates a location of a user;
a second obtaining unit configured to obtain movement information which indicates a movement performed by the user; and
a display controller configured to perform control to display a personification medium on a display unit on which service information indicating information to be offered to the user, the personification medium fixing vision in a direction corresponding to the location specified in the location information and performing a movement in synchronization with the movement specified in the movement information.

2. The device according to claim 1, wherein, when the first obtaining unit obtains a plurality of pieces of the location information in a one-to-one correspondence with a plurality of users, the display controller displays a plurality of the personification mediums in a one-to-one correspondence with the plurality of users on the display unit.

3. The device according to claim 2, wherein
the second obtaining unit obtains the movement information corresponding to at least a single user from among the plurality of users, and
the display controller performs control to display the personification medium which fixes vision in the direction corresponding to the location of the user for which the movement information is obtained and which performs a movement in synchronization with the user on the display unit.

4. The device according to claim 2, wherein
the personification medium is expressed using computer graphics, and
the display controller performs control to display each of the personification mediums in such a way that the personification medium corresponding to a user present at a location specified in the location information is set to a position that lies on a virtual line drawn from a virtual point in a virtual space, which is a rearward portion of a display surface that is a surface of the display unit on which images are displayed, to the location specified in the location information and that is within the virtual space at a distance which is measured from the point of intersection between the virtual line and the display surface and which is equal to the distance between the location specified in the location information and the point of intersection.

5. The device according to claim 2, wherein
the personification medium is expressed using computer graphics, and
the display controller performs control to display each of the personification mediums in such a way that the personification medium corresponding to a user present at a location specified in the location information is set to such a position in a virtual space, which is a rearward portion of a display surface that is a surface of the display unit on which images are displayed, that has a symmetric relation with the location specified in the location information when the display surface is considered to be a plane of mirror symmetry.

6. The device according to claim 1, wherein, the display controller sets a line-of-sight direction of the personification medium in such a way that an angle formed between the normal direction of a display surface, which indicates a surface of the display unit on which images are displayed, and the line-of-sight direction of the personification medium is equal to or smaller than one-third of an angle formed between a direction from the personification medium toward the location specified in the location information and the normal direction of the display surface.

7. The device according to claim 1, further comprising:
a third obtaining unit that obtains user information indicating information related to the user; and
a service information generating unit that generates the service information according to the user information.

8. An information display apparatus comprising:
a first obtaining unit configured to obtain location information which indicates a location of a user;
a second obtaining unit configured to obtain movement information which indicates a movement performed by the user;
a display unit configured to display service information indicating information to be offered to the user; and
a display controller configured to perform control to display, on the display unit, a personification medium which fixes vision in a direction corresponding to the location specified in the location information and which performs a movement in synchronization with the movement specified in the movement information.

9. An information processing method comprising:
obtaining location information which indicates a location of a user;
obtaining movement information which indicates a movement performed by the user; and
performing control to display a personification medium on a display unit on which service information indicating information to be offered to the user, the personification medium fixing vision in a direction corresponding to the location specified in the location information and performing a movement in synchronization with the movement specified in the movement information.

10. A computer program product comprising a computer-readable medium including a computer program that causes a computer to execute:
obtaining location information which indicates a location of a user;
obtaining movement information which indicates a movement performed by the user; and
performing control to display a personification medium on a display unit on which service information indicating information to be offered to the user, the personification medium fixing vision in a direction corresponding to the location specified in the location information and performing a movement in synchronization with the movement specified in the movement information.
